(19) United States
(12) Patent Application Publication
(10) Pub. No.: US 2018/0218819 A1
(43) Pub. Date: Aug. 2, 2018

(54) Magnetic Slide Topper

(71) Applicant: David H. Enz, Denmark, WI (US)

(72) Inventor: David H. Enz, Denmark, WI (US)

(21) Appl. No.: 15/422,870

(22) Filed: Feb. 2, 2017

(51) Int. Cl. H01F 7/02; E04F 10/06

(52) U.S. Cl. CPC H01F 7/0231; E04F 10/06

(57) ABSTRACT

The invention relates to a retrofitted magnetic slide topper including a means for magnetism to provide tension on an awning flexes, a roller tube to provide a rolling base for the awning flexes and a plurality of brackets to mount the roller tube with the means for magnetism using a plurality of clamps. Further, the system includes either electromagnetic or permanent magnets along with base plates or magnetic cores. These can be used in various configurations to push or pull on the awning roller tube or other flexible members to tension and or bow the movable member to force the water off of the awning. The objectives of the present invention is to stop the major water pounding and allowing the awning material to dry instead of creating a swamp causing sages and premature fabric deterioration.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### (1) Field of the Invention

The present invention relates to the field of the roll awning slide topper. The invention, particularly relates to a magnetic slide topper which protects the canvas or awning from the low spot causing the water to pond.

### (2) Background of the Invention

Generally, the awning covering the slide-out seems to collect a large amount of water from rain or heavy dew. This water could eventually run down in windows, streaking them and occasionally leaking through the slide-out seam, getting into the carpet and couch wet. I don't know how often this happens if at all. The weight of the water has also caused the awning to stretch out and flap in the wind. The users are fearful that if left this way, the awning will eventually tear away from the motorhome frame, leaving the entire top of the slide-out exposed to the elements, potentially causing even worse leakage problems.

In conventional, there are several ways to alleviate this problem. The person would often climb to the top rung of a step ladder, use a pole or broom between the top of the slide-out and under the awning and force the water to roll off. Standing on the top rung is not only dangerous, but it is also inconvenient to keep setting up the ladder and putting it away.

There have been a number of solutions provided for protecting the awning from such type of conditions and few of them have been discussed below:

U.S. Pat. No. 8,267,105 B1 discloses a portable magnetic awning apparatus is easily attached to and removed from a chosen metallic vehicle or surface. Soft magnets negate potential scarring. In the collapsed state, the apparatus is importantly relatively small. The scissor frame supporting the awning easily collapses to allow the vertical members to be collapsed inwardly to a side-by-side position, with the pivoting members pivoting upwardly for further compact state. The pliable awning and bib further enable lightweight collapsibility. The pivoting members which are pivotally and positionally lockable, along with the telescopic rods, provide a wide variety of selectively established positioning and extendability. Lock knobs manually lock the pivoting members as chosen relative to the vertical members. The bib is hingedly attached to the awning to further provide selective positioning in relation thereto.

US 20100000689 A1 describes a corner canvas take up shaft to wind up or unwind a corner canvas, the corner canvas takes up shaft comprising: an inner shaft; and an outer roller axially movable on and supported by the inner shaft.

EP 2458107 A3 relates to an articulated-arm awning has rotatably mounted cloth shaft from which a cloth is unwound. The front end of the shaft is fixed to articulated arm. A fixed support is arranged in bottom side of the shaft. The magnets are provided at extended portion and upper end of fixed support. The magnets are detachably connected to corresponding magnets.

The aforesaid documents and other similar solutions may strive to provide an efficient roll awning apparatus; however, they still have a number of limitations and shortcomings such as, but not limited to, protection of the slide toppers pond in the middle that allows water to stand on the fabric, proper retraction of the fabric while the slide is retracted. Virtually all of the prior art devices suffer the characteristic that they add significant complex arrangement of the various modules and further, the system is less economical to the user. The above mentioned prior arts can only perform certain aspects say for example, provides a portable magnetic awning apparatus to provide both extended positioning as well as selectively retained collapsed arrangement. The devices found in the prior art do not provide the convenience, flexibility and economy, which is sought by consumers, and accordingly have been commercially unsuccessful.

Accordingly, there remains a need in the prior art to have an improved system for protecting the awning from the water, i.e. to be pounded and problem raised due to it, therefore overcome the aforesaid problem and shortcomings.

### SUMMARY OF THE INVENTION

In the view of the foregoing disadvantages inherent in the known types of the roll awning now present in the prior art, the present invention provides an improved magnetic slide topper. As such, the general purpose of the present invention, which will be described subsequently in greater detail, is to provide a new and improved magnetic slide topper having a means for magnetized the awning flexes to remove the pounding of water which has all the advantages of the prior art and none of the disadvantages.

An object of the invention is to provide a magnetic slide topper which includes a means for magnetism to provide tension on an awning flexes, a roller tube to provide a rolling base for the awning flexes and a plurality of brackets to mount the roller tube with the means for magnetism using a plurality of clamps.

It is another object of the present invention to provide the system is having a new process for the tensioning of the canvas, awnings or other things when the supporting brackets are not able to be placed in the needed place because of contact with the material to be tensioned and further removing the slack from the awnings such that the water could not pond and hinders retraction as a sake for ease to the user.

It is another object of the present invention to provide the use of means for magnetism to push or pull the roller tube in the center that allows the system to crown the roller and increase the tension on the canvas so the water flows off the edge or over the roller like it should.

It is another object of the present invention to provide the magnetic pull, i.e. energized by a current passing through the means for magnetism which creates a magnetic flux that causes the armature plate to attract to the means for magnetism and further, creating a locking action or magnetic locks for flexible tensioning of awning flexes.

It is another object of the present invention to provide the magnetic locks unlock uniformly when the power is cut, allowing for quick release of the roller tube base and further, the device is unlocked when de-energized.

It is another object of the present invention to provide the system that consists of either electromagnetic or permanent magnets along with base plates or magnetic cores. These can be used in various configurations to push or pull on the awning roller tube or other flexible members to tension and or bow the movable member to force the water off of the awning. The objectives of the present invention is to stop the major water pounding and allowing the awning material to dry instead of creating a swamp causing sage and premature fabric deterioration.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front view of a magnetic slide topper in accordance with an embodiment of the present invention;

FIG. 2 and FIG. 3 illustrate perspective views of a means for magnetism that is installed on the slide topper as shown in FIG. 1;

FIG. 4 represents a tube of the awning according to an embodiment herein; and

FIG. 5 illustrates a side view of the clamp of the magnetic slide topper according to an embodiment herein.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides a magnetic slide topper that includes a means for magnetism (1), a non-magnetic base, a means for actuating, a roller tube (2), a plurality of brackets, a plurality of clamps (3), a plurality of springs, wires, and magnetic locks. The means for magnetism is used to provide tension on an awning flexes and the roller tube is used to provide a rolling base for the awning flexes. Further, the plurality of brackets is positioned to mount the roller tube with the means for magnetism using a plurality of clamps.

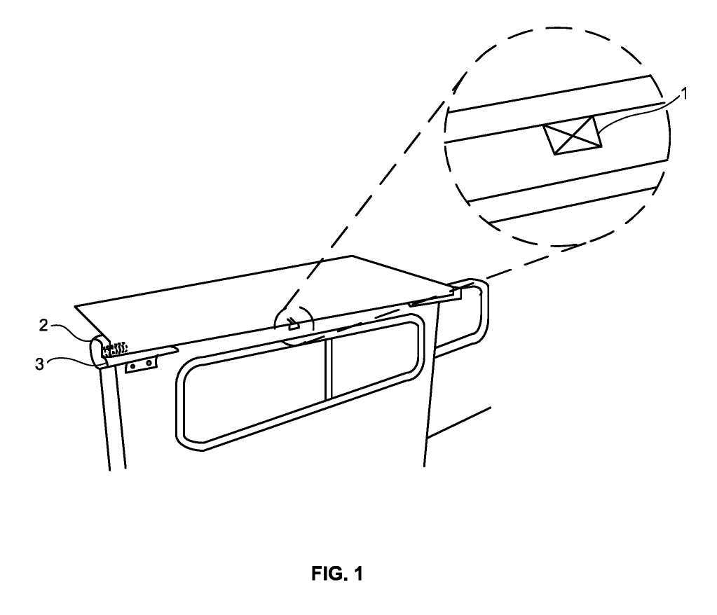

As shown in FIG. 1, a front view of a tensioning device, and more particularly to a magnetic slide topper with a conventional roll awning is having a means for magnetism (1) to protect the slide topper from the pounding of water using a tension mechanism, i.e. generated by a magnetic field and flexing of the awning to the roller tube for a wide range of awning area and providing a user controlled mechanism. The magnetic field is adjusted by the distance between the means for magnetism and the roller tube base. The plurality of brackets (3) supports and positions the magnets or the non-magnetic base for both non-contact with the roller and adjusting the magnetic force by decreasing or increasing the distance between the magnet and the base or the repelling magnet in the housing of the means for magnetism.

In accordance with an embodiment of the present invention, the non-magnetic base is supported by the plurality of brackets without any contact of the roller tube frame. The roller tube (2) is used to roll up and providing tension to the awning of the slide topper. The roller tube travels in and out with the slide out and is attached to the outer edge of the slide out with the plurality of brackets and bushings on each end. There is a spring inside the roller tube that keeps the fabric tight. The roller tube tensions and rolls the awning fabric to move the slide out. The roller tube rolls the awning fabric up like a shade when the slide is retracted. The magnetic slide topper with a conventional roll awning is preferably made from stainless steel, various numbers of magnets, or otherwise fabricated from a combination thereof although other suitable construction materials may be used. As per the convenience of users, preferably, it would be easier and more efficient, but not limited to, push the roller tube to crown and tension the awning from the bottom rather than pull it from the top. The magnetic tensioning device can be retrofitted to an existing awnings and/or RV awning systems.

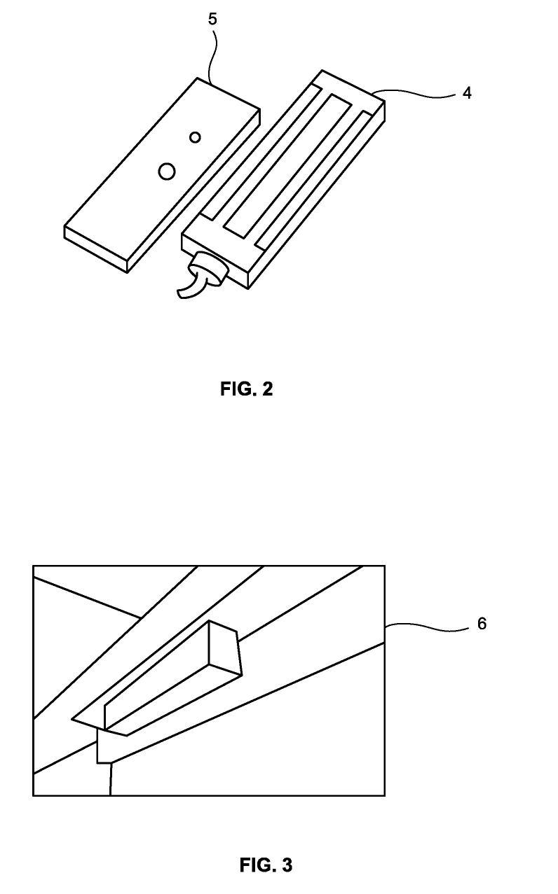

Referring to FIG. 2 and FIG. 3 show perspective views of a means for magnetism that is installed on the slide topper. The magnetic slide topper enables the user to tension the awning electrically by turning on an electric switch thereby energizing the magnet. This method would allow the roller tube to go back to its original shape when the awning is dry and retracting the slide. The electrical means (4) is used to enable the user for dumping the water off from the awning to reduce the pounding and soiling of the awning fabric. This could reduce stress on the roller tube during dry times.

In accordance with an embodiment of the present invention, the electromagnetic lock is providing a tension to the awning fabric by creating a magnetic pull while the roller tube armature is attracted to the base. When the electromagnet is energized, a current passing through the electromagnet creates a magnetic flux that causes the armature plate to attract to the electromagnet, creating a locking action or a magnet lock (5) which creates the tension. Further, the mating area of the electromagnet and tube armature is relatively large, the force created by the magnetic flux is strong enough to hold the awning roller tube in tensioned position, and not allowing water to pond on the awning fabric. Furthermore, a battery is configured to provide the power for an electromagnet lock in the form of direct current. Preferably, the direct current, but not limited to, around 5-6 W with 0.5 when the voltage supply is 12VDC and 0.25 A while using 24VDC, although the values can be varied as per the manufacturer requirement.

The magnet base material or the magnet would be placed in the hollow tube of the housing (6) of the means for magnetism so magnetic forces enable the awning fabric for flexing with respect to the roller tube that same moves up and away, causing the center of the awning to be the pitched to the ends. Preferably, the base is, but not limited to, made in the clamping structure to enable the user for adjusting the system pulling up and away. Further, the curved base is, but not limited to, having the most pull coming towards the top which guides the bar up and away. Also, the user should be able to position it themselves as per their need, albeit, up and away is ideal. The different locations and arrangements of the magnets and base material, preferably, but not limited to, a repelling magnet would be used as a sake of ease to the user. The magnetic slide topper may be fitted with any kind of conventional home awning system or RV awning system.

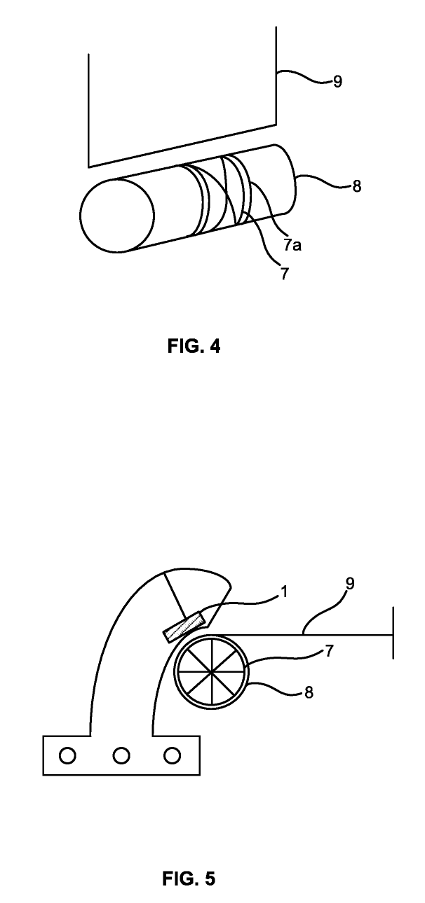

FIG. 4 represents a tube (8) of the awning according to an embodiment herein. The tube (8) may be fitted with a magnetic base matt (7) from the inside. The fabric (9) rolls over the tube (8). The tube (8) further includes a bracket (7a) to fit the slide in or out. A user may push/pull the bracket in order to adjust the magnet inside the tube (8).

FIG. 5 illustrates a side view of the clamp of the magnetic slide topper according to an embodiment herein. The clamp includes a magnetism means (1) that acts as a magnet and the magnetic base matt (7). The magnetic base matt (7) is coupled using an adhesive inside the tube (8) of the awning. The clamp may incorporate as many magnets as possible. More the number of magnets, more would be the magnetism, and more would be the tensioning force.

The above-mentioned magnetic slide topper provides a flexible system for protecting the canvas or awning from the low spot causing the water to pond. The system in which the water does not pond on the fabric of the awning using the means for magnetism to push or pull the roller tube in the center allows the user to crown the roller tube and increase the tension on the canvas so the water flows off the edge or over the roller tube. Further, the distance between the magnets is adjustable on bracket. In addition, the components of the magnetic slide topper are detachable from each other that makes the system more flexible and portable with easy installation on the conventional roll awning. Also, the size and dimension of whole components of the system can be manufactured as per the requirement of the user. The magnetic slide topper can be easily replaced with the conventional roll awning and very economical in use.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A magnetic slide topper, comprising:
a means for magnetism to provide tension on an awning flexes;
a roller tube that is adapted to provide a rolling base for said awning flexes; and
a plurality of brackets to mount said roller tube with said means for magnetism using a plurality of clamps.

2. The magnetic slide topper according to claim 1, wherein said means for magnetism is used to provide a magnetic field to said awning flexes.

3. The magnetic slide topper according to claim 2, wherein said magnetic field is adjusted by distance between said means for magnetism and said roller tube base.

4. The magnetic slide topper according to claim 1, wherein said means for magnetism magnetizes said roller tube for creating tension to said awning flexes.

5. The magnetic slide topper according to claim 1, wherein said means for magnetism is supported by a non-magnetic base.

6. The magnetic slide topper according to claim 5, wherein said non-magnetic base is further supported by said plurality of brackets with non-contact of said roller tube frame.

7. The magnetic slide topper according to claim 1, wherein said magnetism pulls and locks an armature of said roller tube using a magnetic flux.

8. The magnetic slide topper according to claim 1, wherein said means for magnetism is activated by a means for actuating.

9. The magnetic slide topper according to claim 1, wherein said means for magnetism is selected from a plurality of neodymium magnets, an electromagnetic electric motor and a combination thereof.

10. The magnetic slide topper according to claim 8, wherein said means for actuating is selected from a mechanical device and an electric switch.

11. The magnetic slide topper according to claim 1, wherein said magnetic slide topper is retrofitted on an existing awning system.

12. A retrofitted magnetic slide topper, comprising:
a means for magnetism supported by a non-magnetic base, to provide tension on an awning flexes;
a roller tube that is adapted to provide a rolling base for said awning flexes; and
a plurality of brackets to mount said roller tube with said means for magnetism using a plurality of clamps.
